(19) United States
(12) Patent Application Publication
(10) Pub. No.: US 2018/0072839 A1
(43) Pub. Date: Mar. 15, 2018

(54) RESIN COMPOSITION FOR OPTICAL MATERIAL, RESIN FOR OPTICAL MATERIAL, AND OPTICAL LENS MADE THEREFROM

(71) Applicant: Chi Mei Corporation, Tainan City (TW)

(72) Inventors: Hsiu-Mei Wu, Tainan City (TW); Yi-Hsiu Huang, Tainan City (TW); Chan-Li Hsueh, Tainan City (TW)

(73) Assignee: Chi Mei Corporation, Tainan City (TW)

(21) Appl. No.: 15/681,411

(22) Filed: Aug. 20, 2017

(30) Foreign Application Priority Data
Sep. 13, 2016 (TW) 105129866

(51) Int. Cl. C08G 18/72; C08G 18/83

(52) U.S. Cl. CPC C08G 18/72; G02B 1/041; C08G 18/834

(57) ABSTRACT

A resin composition for an optical material contains a thiol compound and an isocyanate compound. The thiol compound includes a trithiol compound and a tetrathiol compound, and based on 100% of the total mole equivalent of the thiol group of the thiol compound, the total mole equivalent of the thiol group of the trithiol compound is fro 85% to 95%, and the total mole equivalent of the thiol group of the tetrathiol compound is from 5% to 15%. The isocyanate compound includes dicyclohexylmethane diisocyanate, and based on 100% of the total mole equivalent of the isocyanate group of the isocyanate compound, the total mole equivalent of the isocyanate group of the dicyclohexylmethane diisocyanate is from 90% to 100%.

### CROSS-REFERENCE TO RELATED APPLICATION

This application claims the priority benefit of Taiwan application serial no. 105129866, filed on Sep. 13, 2016. The entirety of the above-mentioned patent application is hereby incorporated by reference herein and made a part of this specification.

### BACKGROUND OF THE INVENTION

### Field of the Invention

The invention relates to a resin composition technique, and more particularly, to a resin composition for an optical material, a resin for an optical material, and an optical lens made therefrom.

### Description of Related Art

To make an optical lens having good optical properties, a resin composition containing a thiol compound and an isocyanate compound has been studied and used as a resin for an optical material after casting polymerization. However, the research shows that the optical lens made by the resin for an optical material is unsatisfactory in terms of heat distortion temperature (HDT).

Therefore, a resin composition for an optical material having good heat resistance properties in addition to good optical properties is urgently needed.

### SUMMARY OF THE INVENTION

The invention provides a resin composition for an optical material, a resin for an optical material, an optical lens formed by the composition or the resin, and a manufacturing method of the optical material that can manufacture an optical lens having properties such as low specific gravity, high heat distortion temperature, and low yellowing.

A resin composition for an optical material of the invention contains a thiol compound and an isocyanate compound. The thiol compound includes a trithiol compound and a tetrathiol compound, and based on 100% of the total mole equivalent of the thiol group of the thiol compound, the total mole equivalent of the thiol group of the trithiol compound is from 85% to 95%, and the total mole equivalent of the thiol group of the tetrathiol compound is from 5% to 15%. The isocyanate compound includes dicyclohexylmethane diisocyanate, and based on 100% of the total mole equivalent of the isocyanate group of the isocyanate compound, the total mole equivalent of the isocyanate group of the dicyclohexylmethane diisocyanate is from 90% to 100%.

An optical lens of the invention is made by the resin composition for optical material.

A resin for an optical material of the invention contains a thiol compound unit and an isocyanate compound unit. The thiol compound unit includes a trithiol compound unit and a tetrathiol compound unit, and based on 100% of the total mole equivalent of the thiol group residue of the thiol compound unit, the total mole equivalent of the thiol group residue of the trithiol compound unit is from 85% to 95%, and the total mole equivalent of the thiol group residue of the tetrathiol compound unit is from 5% to 15%. The isocyanate compound unit includes a dicyclohexylmethane diisocyanate unit, and based on 100% of the total mole equivalent of the isocyanate group residue of the isocyanate compound unit, the total mole equivalent of the isocyanate group residue of the dicyclohexylmethane diisocyanate unit is from 90% to 100%.

An optical lens of the invention is made by the resin for optical material.

A manufacturing method of an optical material of the invention contains mixing a thiol compound and an isocyanate compound. The thiol compound includes a trithiol compound and a tetrathiol compound, and based on 100% of the total mole equivalent of the thiol group of the thiol compound, the total mole equivalent of the thiol group of the trithiol compound is from 85% to 95%, and the total mole equivalent of the thiol group of the tetrathiol compound is from 5% to 15%; and the isocyanate compound comprises a dicyclohexylmethane diisocyanate, and based on 100% of the total mole equivalent of the isocyanate group of the isocyanate compound, the total mole equivalent of the isocyanate group of the dicyclohexylmethane diisocyanate is from 90% to 100%.

Based on the above, the resin composition for an optical material of the invention contains a specific range of dicyclohexylmethane diisocyanate and a specific range of the trithiol compound and the tetrathiol compound, and therefore by mixing a specific thiol compound and a specific isocyanate compound, a resin composition for an optical material, a resin for an optical material, and an optical lens having properties such as low specific gravity, high heat distortion temperature, and low yellowing can be obtained.

In order to make the aforementioned features and advantages of the invention more comprehensible, embodiments are described in detail below.

### DESCRIPTION OF THE EMBODIMENTS

In the following, the embodiments of the invention are described in detail. However, these embodiments are exemplary, and the invention is not limited thereto.

In an embodiment of the invention, the resin composition for an optical material contains a thiol compound and an isocyanate compound. The thiol compound includes a trithiol compound and a tetrathiol compound. Based on 100% of the total mole equivalent of the thiol group of the thiol compound, the total mole equivalent of the thiol group of the trithiol compound is from 85% to 95%, and the total mole equivalent of the thiol group of the tetrathiol compound is from 5% to 15%. In an embodiment, the trithiol compound at least includes 2,3-bis(2-mercaptoethylthio)-1-propanethiol, and the tetrathiol compound at least includes pentaerythritol tetrakis(3-mercaptopropionate). The isocyanate compound includes dicyclohexylmethane diisocyanate, and based on 100% of the total mole equivalent of the isocyanate group of the isocyanate compound, the total mole equivalent of the isocyanate group of the dicyclohexylmethane diisocyanate is from 90% to 100%. Moreover, other than dicyclohexylmethane diisocyanate, the isocyanate compound can further include an alicyclic isocyanate compound other than dicyclohexylmethane diisocyanate, and based on 100% of the total mole equivalent of the isocyanate group of the isocyanate compound, the total mole equivalent of the isocyanate group of the alicyclic isocyanate compound is, for instance, 10% or less. In an embodiment, based on 100% of the total mole equivalent of the isocyanate group of the isocyanate compound, the total mole equivalent of the thiol group of the thiol compound is, for instance, from 90% to 110%.

In yet another embodiment of the invention, the manufacturing method of the optical material contains mixing the above-mentioned thiol compound and the above-mentioned isocyanate compound.

In another embodiment of the invention, the resin for the optical material contains a thiol compound unit and an isocyanate compound unit. Here, “thiol compound unit” refers to a structural unit formed by performing the copolymerization reaction of a thiol compound, and “isocyanate compound unit” refers to a structural unit formed by performing the copolymerization reaction of an isocyanate compound; so on and so forth. Based on 100% of the total mole equivalent of the thiol group residue of the thiol compound unit, the total mole equivalent of the thiol group residue of the trithiol compound unit is from 85% to 95%, and the total mole equivalent of the thiol group residue of the tetrathiol compound unit is from 5% to 15%. Preferably, the total mole equivalent of the thiol group residue of the trithiol compound unit is from 87% to 93%, and the total mole equivalent of the thiol group residue of the tetrathiol compound unit is from 7% to 13%. More preferably, the total mole equivalent of the thiol group residue of the trithiol compound unit is from 88% to 92%, and the total mole equivalent of the thiol group residue of the tetrathiol compound unit is from 8% to 12%. In an embodiment, the trithiol compound unit at least includes a 2,3-bis(2-mercaptoethylthio)-1-propanethiol unit, and the tetrathiol compound unit at least includes a pentaerythritol tetrakis(3-mercaptopropionate) unit. The isocyanate compound unit includes a dicyclohexylmethane diisocyanate unit, and based on 100% of the total mole equivalent of the isocyanate group residue of the isocyanate compound unit, the total mole equivalent of the isocyanate group residue of the dicyclohexylmethane diisocyanate unit is from 90% to 100%. Preferably, the total mole equivalent of the isocyanate group residue of the dicyclohexylmethane diisocyanate unit is from 92% to 100%. More preferably, the total mole equivalent of the isocyanate group residue of the dicyclohexylmethane diisocyanate unit is from 95% to 100%. Moreover, other than the dicyclohexylmethane diisocyanate unit, the isocyanate compound unit can further include an alicyclic isocyanate compound unit other than the dicyclohexylmethane diisocyanate unit, and based on 100% of the total mole equivalent of the isocyanate group residue of the isocyanate compound unit, the total mole equivalent of the isocyanate group residue of the alicyclic isocyanate compound unit is, for instance, 10% or less; preferably 8% or less; and more preferably 5% or less. In an embodiment, based on 100% of the total mole equivalent of the isocyanate group residue of the isocyanate compound unit, the total mole equivalent of the thiol group residue of the thiol compound unit is, for instance, from 90% to 110%. Here, “thiol group residue of thiol compound unit” refers to a residual group formed in a structural unit by performing the copolymerization reaction of a thiol group of a thiol compound, “isocyanate group residue of isocyanate compound unit” refers to a residual group formed in a structural unit by performing the copolymerization reaction of an isocyanate group of an isocyanate compound; so on and so forth.

The components mentioned in the invention are described in detail below.

<Thiol Compound>

The thiol compound of the invention includes a trithiol compound and a tetrathiol compound. The trithiol compound can include, for instance, but is not limited to, at least one selected from the group consisting of 1,2,3-trimercaptobenzene, 1,2,4-trimercaptobenzene, 1,3,5-trimercaptobenzene, 1,2,3-tris(mercaptomethyl)benzene, 1,2,4-tris(mercaptomethyl)benzene, 1,3,5-tris(mercaptomethyl)benzene, 2,3-bis(2-mercaptoethylthio)-1-propanethiol (DMPT), trimethylolpropane tris(3-mercaptopropionate), ethylolethane tris(3-mercaptopropionate), trimethylolpropane tris(2-mercaptoacetate), trimethylolethane tris(2-mercaptoacetate), glycerol tris(3-mercaptopropionate), trimercapto isocyanurate, 2,4,6-tris(mercaptomethyl)-1,3,5-trithalane, 2,4,6-tris(mercaptoethyl)-1,3,5-trithalane, 2-(2-mercaptoethylthio)propane-1,3-dithiol, 2-(2,3-bis(2-mercaptoethylthio)propylthio)ethanethiol, 1,2-bis(2-mercaptoethylthio)-3-mercaptopropane, and 3-(3-mercapto-propionylsulfanyl)-propionic acid 2-hydroxylmethyl-3-(3-mercapto-propionyloxy)-2-(3-mercapto-propionyloxymethyl)-pr opyl ester. In the present embodiment, the trithiol compound is preferably DMPT, 1,2-bis(2-(2-mercaptoethylthio)-3-mercaptopropane, trimethylolpropane tris(3-mercaptopropionate), or a combination thereof. The trithiol compound can be used alone or in combination. In the present embodiment, the trithiol compound is most preferably DMPT.

The tetrathiol compound can include, for instance, but is not limited to, at least one selected from the group consisting of 2,2-bis(mercaptomethyl)-1,3-propane dithiol, 3,3′-dithiobis(propane-1,2-dithiol), tetrakis(mercaptomethyl)methane, bis(2,3-dimercaptopropanol)sulfide, bis(2,3-dimercaptopropanol)disulfide, bis(2-(2-mercaptoethylthio)-3-mercaptopropyl)sulfide, 1,2-bis(2-(2-mercaptoethylthio)-3-mercaptopropylthio)ethane, 5,7-dimercaptomethyl-1,11-dimercapto-3,6,9-trithiaundecane, 4,7-dimercaptomethyl-1,11-dimercapto-3,6,9-trithiaundecane, 4,8-dimercaptomethyl-1,11-dimercapto-3,6,9-trithiaundecane, 1,1,3,3-tetrakis(mercaptomethylthio)propane, 1,1,2,2-tetrakis(mercaptomethylthio)ethane, pentaerythritol tetrakis(3-mercaptopropionate) (PETMP), pentaerythritol tetrakis(2-mercaptoacetate), pentaerythritol tetrakis(4-mercaptobutanate), pentacrythritol tetrakis(5-mercaptopentanate), and pentaerythritol tetrakis(6-mercaptohexanate); in the present embodiment, the tetrathiol compound is preferably PETMP, pentaerythritol tetrakis(2-mercaptoacetate), 1,1,3,3-tetrakis(mercaptomethylthio)propane, 1,1,2,2-tetrakis(mercaptomethylthio)ethane, or a combination thereof. The tetrathiol compound can be used alone or in combination. In the present embodiment, the tetrathiol compound is most preferably PETMP.

Based on 100% of the total mole equivalent of the thiol group of the thiol compound, when the total mole equivalent of the thiol group of the trithiol compound is from 85% to 95%, the total mole equivalent of the thiol group of the tetrathiol compound is from 5% to 15%, and heat resistance can be increased. Preferably, the total mole equivalent of the thiol group of the trithiol compound is from 87% to 93%, and the total mole equivalent of the thiol group of the tetrathiol compound is from 7% to 13%. More preferably, the total mole equivalent of the thiol group of the trithiol compound is from 88% to 92%, and the total mole equivalent of the thiol group of the tetrathiol compound is from 8% to 12%.

<Isocyanate Compound>

The isocyanate compound of the invention includes dicyclohexylmethane diisocyanate (H₁₂MDI). Based on 100% of the total mole equivalent of the isocyanate group in the isocyanate compound, when the total mole equivalent of the isocyanate group of the H₁₂MDI is from 90% to 100%, lens yellowing can be reduced. Preferably, the total mole equivalent of the isocyanate group of the H₁₂MDI is from 92% to 100%. More preferably, the total mole equivalent of the isocyanate group of the H₁₂MDI is from 95% to 100%.

The isocyanate compound of the invention can further include an alicyclic isocyanate compound other than the H₁₂MDI. The alicyclic isocyanate compound can include, for instance, but is not limited to, at least one selected from the group consisting of isophorone diisocyanate (IPDI), norbornane dimethyleneisocyanate (NBDI), 1,3-bis(isocyanatomethyl)cyclohexane (XDI), 1,4-cyclohexane diisocyanate (CHDI), 3,8-bis(isocyanatomethyl)tricyclo[5,2,1,0^{2,6}]decane, 3,9-bis(isocyanatomethyl)tricyclo[5,2,1,0^{2,6}]decane, 4,8-bis(isocyanatomethyl)tricyclo[5,2,1,0^{2,6}]decane, 4,9-bis(isocyanatomethyl)tricyclo[5,2,1,0^{2,6}]decane, 2,5-bis(isocyanatomethyl)bicyclo[2,2,1]heptane, and 2,6-bis(isocyanatomethyl)bicyclo[2,2,1]heptane. In the present embodiment, the alicyclic isocyanate compound is preferably IPDI. The alicyclic isocyanate compound can be used alone or in combination.

Based on 100% of the total mole equivalent of the isocyanate group of the isocyanate compound, when the total mole equivalent of the isocyanate group of the alicyclic isocyanate compound is, for instance, 10% or less, a lower specific gravity can be obtained. Preferably, the total mole equivalent of the isocyanate group of the alicyclic isocyanate compound is 8% or less. More preferably, the total mole equivalent of the isocyanate group of the alicyclic isocyanate compound is 5% or less.

In the following, several experiments are provided to more specifically describe the resin composition for an optical material and the resin for an optical material of the invention. Although the following experiments are described, the materials used and the amounts and ratios thereof, as well as handling details and handling process, etc., can be suitably modified without exceeding the scope of the invention. Accordingly, restrictive interpretation should not be made to the invention based on the experiments described below.

The evaluation methods of heat distortion temperature, yellowing, and specific gravity of each component made in the following experiments are as follows:

<Heat Distortion Temperature>

A sample test piece of 8 mm length×8 mm width×3 mm height was heated at a heating rate of 5° C./minute using a thermomechanical analyzer with the model number Q400 made by TA Corporation to test the heat distortion temperature thereof.

<Yellowing>

Yellow index (YI) in long optical path: a round test piece (650 mm diameter×3 mm thickness) was measured via long optical path by a spectrophotometer (MINOLTA CM5).

<Specific Gravity>

Measurement was performed using SD-120L made by ALFAMIRAGE Corporation.

Each component used in the experimental examples and the comparative examples was prepared as follows:

<Raw Materials>

1. Trithiol compound: 2,3-bis(2-mercaptoethylthio)-1-propanethiol (DMPT) (Mw: 260.53 g/mol)

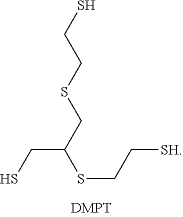 [SMILES: SCCSCC(CS)SCCS]

2. Tetrathiol compound: pentaerythritol tetrakis(3-mercaptopropionate) (PETMP) (Mw: 488.66 g/mol)

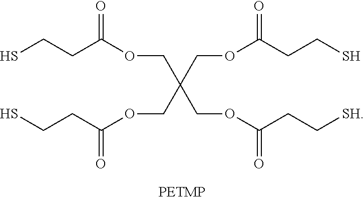 [SMILES: O=C(CCS)OCC(COC(=O)CCS)(COC(=O)CCS)COC(=O)CCS]

3. Dicyclohexylmethane diisocyanate (H₁₂MDI) (Mw: 262 g/mol)

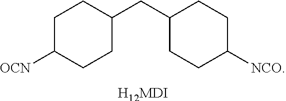

4. Alicyclic isocyanate compound: isophorone diisocyanate (IPDI), norbornane dimethyleneisocyanate (NBDI).

### Experimental Example 1

88.8 g of H₁₂MDI, 52.9 g of DMPT, and 8.27 g of PETMP were mixed.

The calculation method of mole equivalent of the components is as follows.

H₁₂MDI: 88.8 g/262 g/mol=0.3389 mol×2 equivalent (functional group)=0.6778 mole equivalent.

DMPT: 52.9 g/260.53 g/mol=0.2030 mol×3 equivalent (functional group)=0.6090 mole equivalent.

PETMP: 8.27 g/488.66 g/mol=0.0169 mol×4 equivalent (functional group)=0.0676 mole equivalent.

Next, 0.3% (based on parts by weight of the entire isocyanate compound and thiol compound) of dibutyltin dichloride was added in a mixing bucket provided with a stirrer to perform stirring under reduced pressure. After stirring was complete, the mixture was defoamed under educed pressure and injected into a glass mold.

The glass mold in which the mixture was injected was heated from 30° C. to 130° C. to react for 24 hours. After heating and curing, the glass mold was taken out and cooled at room temperature to obtain a cured product. Next, the cured product was removed from the mold to obtain an optical lens. The resulting optical lens was evaluated by each evaluation method, and the results are as shown in Table 1.

### Comparative Examples 1 to 2

The same preparation method as experimental example 1 was used, and the difference is that the amounts of the raw materials in the resin composition for an optical material were changed. The results are as shown in Table 1.

### Experimental Example 2

The same preparation method as experimental example 1 was used, and the difference is that 84.35 g of H₁₂MDI was used in the resin composition for an optical material, and 3.79 g of IPDI was added. The results are as shown in Table 1.

### Experimental Example 3 and Comparative Example 3

The same preparation method as experimental example 2 was used, and the difference is that the amounts of the raw materials in the resin composition for an optical material were changed. The results are as shown in Table 1.

### Comparative Example 4

The same preparation method as experimental example I was used, and the difference is that H₁₂MDI was replaced by NBDI in the resin composition for an optical material. The results are as shown in Table 1.

TABLE 1

| | | Experimental example | | | Comparative example | | | |
|---|---|---|---|---|---|---|---|---|
| | | 1 | 2 | 3 | 1 | 2 | 3 | 4 |
| Isocyanate | H₁₂MDI | 100% | 95% | 90% | 100% | 100% | 85% | 0 |
| compound | IPD1 | 0 | 5% | 10% | 0 | 0 | 15% | 0 |
| | NBDI | 0 | 0 | 0 | 0 | 0 | 0 | 100% |
| Thiol | DMPT | 90% | 90% | 90% | 80% | 100% | 90% | 90% |
| compound | PETMP | 10% | 10% | 10% | 20% | 0 | 10% | 10% |
| Evaluation | Heat | 108.3 | | | 106.5 | 105.7 | | |
| method | distortion | | | | | | | |
| | temperature | | | | | | | |
| | (° C.) | | | | | | | |
| | Yellowing | 1.31 | 1.50 | 1.72 | | | 1.95 | |
| | Specific | 1.22 | | | | | | 1.30 |
| | gravity | | | | | | | |

The percentages (%) in Table 1 represent the total mole equivalent ratio of thiol group/isocyanate group in each component.

First, referring to Table 1, experimental example 1 and comparative examples 1 and 2 have the same content of the isocyanate compound, but in terms of the trithiol compound and the tetrathiol compound, the contents of comparative examples 1 and 2 are not within the limited range of the invention. Therefore, it can be known from the results of heat distortion temperature that, the optical lens made by the resin composition for an optical material of the invention can have a higher heat distortion temperature.

It can be known from the test results of experimental examples 1 to 3 and comparative example 3 that, in terms of dicyclohexylmethane diisocyanate, only the optical lens made within the limited range of the invention can have less yellowing.

Moreover, it can be known from the measurement results of experimental example 1 and comparative example 4 that, a lower specific gravity can only be achieved by using dicyclohexylmethane diisocyanate in the components.

Based on the above, the resin composition for an optical material of the invention has an isocyanate compound in a specific range to improve the issue of yellowing, and it is used with a trithiol compound and a tetrathiol compound in a specific range such that the optical lens can have a higher heat distortion temperature. Moreover, by using a specific isocyanate compound, a resin composition for an optical material, a resin for an optical material, and an optical lens having a low specific gravity can be obtained.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

1. A resin composition for an optical material, comprising:
a thiol compound comprising a trithiol compound and a tetrathiol compound, wherein based on 100% of a total mole equivalent of a thiol group of the thiol compound, a total mole equivalent of a thiol group of the trithiol compound is from 85% to 95%, and a total mole equivalent of a thiol group of the tetrathiol compound is from 5% to 15%; and
an isocyanate compound comprising a dicyclohexylmethane diisocyanate, wherein based on 100% of a total mole equivalent of an isocyanate group of the isocyanate compound, a total mole equivalent of an isocyanate group of the dicyclohexylmethane diisocyanate is from 90% to 100%.

2. The resin composition for the optical material of claim 1, wherein the total mole equivalent of the isocyanate group of the dicyclohexylmethane diisocyanate is from 92% to 100%.

3. The resin composition for the optical material of claim 2, wherein the total mole equivalent of the isocyanate group of the dicyclohexylmethane diisocyanate is from 95% to 100%.

4. The resin composition for the optical material of claim 1, wherein the total mole equivalent of the thiol compound of the trithiol compound is from 87% to 93%, and the total mole equivalent of the thiol group of the tetrathiol compound is from 7% to 13%.

5. The resin composition for the optical material of claim 4, wherein the total mole equivalent of the thiol compound of the trithiol compound is from 88% to 92%, and the total mole equivalent of the thiol group of the tetrathiol compound is from 8% to 12%.

6. The resin composition for the optical material of claim 1, wherein the isocyanate compound further comprises an alicyclic isocyanate compound other than the dicyclohexylmethane diisocyanate, and based on 100% of the total mole equivalent of the isocyanate group of the isocyanate compound, a total mole equivalent of an isocyanate group of the alicyclic isocyanate compound is 10% or less.

7. The resin composition for the optical material of claim 6, wherein the total mole equivalent of the isocyanate group of the alicyclic isocyanate compound is 8% or less.

8. The resin composition for the optical material of claim 7, wherein the total mole equivalent of the isocyanate group of the alicyclic isocyanate compound is 5% or less.

9. The resin composition for the optical material of claim 1, wherein based on 100% of the total mole equivalent of the isocyanate group of the isocyanate compound, the total mole equivalent of the thiol group of the thiol compound is from 90% to 110%.

10. The resin composition for the optical material of claim 1, wherein the trithiol compound at least comprises 2,3-bis(2-mercaptoethylthio)-1-propanethiol, and the tetrathiol compound at least comprises pentaerythritol tetrakis(3-mercaptopropionate).

11. An optical lens made by the resin composition for the optical material of claim 1.

12. A resin for an optical material, comprising:
a thiol compound unit comprising a trithiol compound unit and a tetrathiol compound unit, wherein based on 100% of a total mole equivalent of a thiol group residue of the thiol compound unit, a total mole equivalent of a thiol group residue of the trithiol compound unit is from 85% to 95%, and a total mole equivalent of a thiol group residue of the tetrathiol compound unit is from 5% to 15%; and
an isocyanate compound unit comprising a dicyclohexylmethane diisocyanate unit, wherein based on 100% of a total mole equivalent of an isocyanate group residue of the isocyanate compound unit, a total mole equivalent of an isocyanate group residue of the dicyclohexylmethane diisocyanate unit is from 90% to 100%.

13. The resin for the optical material of claim 12, wherein the total mole equivalent of the isocyanate group residue of the dicyclohexylmethane diisocyanate unit is from 92% to 100%.

14. The resin for the optical material of claim 13, wherein the total mole equivalent of the isocyanate group residue of the dicyclohexylmethane diisocyanate unit is from 95% to 100%.

15. The resin for the optical material of claim 12, wherein the total mole equivalent of the thiol group residue of the trithiol compound unit is from 87% to 93%, and the total mole equivalent of the thiol group residue of the tetrathiol compound unit is from 7% to 13%.

16. The resin for the optical material of claim 15, wherein the total mole equivalent of the thiol group residue of the trithiol compound unit is from 88% to 92%, and the total mole equivalent of the thiol group residue of the tetrathiol compound unit is from 8% to 12%.

17. The resin for the optical material of claim 12, wherein the isocyanate compound unit further comprises an alicyclic isocyanate compound unit other than the dicyclohexylmethane diisocyanate unit, and based on 100% of the total mole equivalent of the isocyanate group residue of the isocyanate compound unit, a total mole equivalent of an isocyanate group residue of the alicyclic isocyanate compound unit is 10% or less.

18. The resin for the optical material of claim 17, wherein the total mole equivalent of the isocyanate group residue of the alicyclic isocyanate compound unit is 8% or less.

19. The resin for the optical material of claim 18, wherein the total mole equivalent of the isocyanate group residue of the alicyclic isocyanate compound unit is 5% or less.

20. The resin for the optical material of claim 12, wherein based on 100% of the total mole equivalent of the isocyanate group residue of the isocyanate compound unit, the total mole equivalent of the thiol group residue of the thiol compound unit is from 90% to 110%.

21. The resin for the optical material of claim 12, wherein the trithiol compound unit at least comprises a 2,3-bis(2-mercaptoethylthio)-1-propanethiol unit, and the tetrathiol compound unit at least comprises a pentaerythritol tetrakis(3-mercaptopropionate) unit.

22. An optical lens made by the resin for the optical material of claim 12.

23. A manufacturing method of an optical material, comprising:
mixing a thiol compound and an isocyanate compound, wherein
the thiol compound comprises a trithiol compound and a tetrathiol compound, and based on 100% of a total mole equivalent of a thiol group of the thiol compound, a total mole equivalent of a thiol group of the trithiol compound is from 85% to 95%, and a total mole equivalent of a thiol group of the tetrathiol compound is from 5% to 15%; and
the isocyanate compound comprises a dicyclohexylmethane diisocyanate, and based on 100% of a total mole equivalent of an isocyanate group of the isocyanate compound, a total mole equivalent of an isocyanate group of the dicyclohexylmethane diisocyanate is from 90% to 100%.
